(19) United States
(12) Patent Application Publication
(10) Pub. No.: US 2003/0194070 A1
(43) Pub. Date: Oct. 16, 2003

(54) Method of billing charge for used functions of communication device, method of regulating function of communication device, customer center for carrying out the method, and an user system including the communication device

(76) Inventors: Fumio Shibasaki, Sagamihara-shi (JP); Takeshi Makita, Hino-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/401,677

(22) Filed: Mar. 31, 2003

(30) Foreign Application Priority Data
Apr. 12, 2002 (JP) 2002-110850

(51) Int. Cl. H04M 15/00

(52) U.S. Cl. 379/114.01

(57) ABSTRACT

A key telephone apparatus BT periodically transmits actual-use information including a part of a service function group and use amount of each service function to a customer center CC via a public network PNW. The customer center CC calculates a use charge of each service function based on the received actual-use information, and notifies a user's maintenance personal computer PC of the use charge via Internet INW. Subsequently, confirming payment of the use charge for each service function by a user, the customer center CC creates a license code for changing a flag indicating a regulation state of the service function of the key telephone apparatus BT to transmit the license code to the corresponding key telephone apparatus BT based on the payment.

### CROSS-REFERENCE TO RELATED APPLICATIONS

This application is based upon and claims the benefit of priority from the prior Japanese Patent Application No. 2002-110850, filed Apr. 12, 2002, the entire contents of which are incorporated herein by reference.

### BACKGROUND OF THE INVENTION

1. Field of the Invention

The present invention relates to a method of billing a charge for used functions of a communication device used in billing the charge for the used functions of, for example, an electronic private branch exchange or key telephone apparatus used in regulating the functions of the communication device, and a customer center which performs a billing process and function regulating process, and a user system including the communication device.

2. Description of the Related Art

In offices, schools, and the like, communication apparatuses such as electronic private branch exchanges, key telephone apparatuses, and facsimile devices have been widely used. When purchasing such communication apparatuses, users generally select the devices including the necessary optional service functions in addition to basic service functions at this time.

However, after the communication apparatus starts to be used, it may be necessary to add another optional service function of the device in accordance with an increase in personnel, change in contents of business, and the like or to eliminate unnecessary optional service functions. In this case, for example, the user has heretofore informed a maker's customer center or the like that the user wants to add the optional service functions. Depending on the contents, a maintenance man is dispatched to the installation place of the communication apparatus and does a setting work of adding functions desired by the user to the communication apparatus.

Additionally, in the conventional changing method, most of works ranging from acceptance of a user's function changing request to the changing of the function of the communication apparatus are carried out manually by the maintenance man dispatched from the customer center. Consequently, it takes much time and labor from when the user informs the customer center of the function changing request until the function is changed.

Therefore, the user not only cannot use the new functions immediately but also has to pay traveling expenses and installation expenses in addition to cost of the added functions, resulting in an increase in the expenses. On the other hand, the customer center must estimate the number of occurrences of function changing requests and secure as many maintenance men as correspond to the number of occurrences, which causes problems of increasing the cost and permitting variations in the quality of the work to take place depending on the maintenance man.

A possible measure to avoid this problem comprises purchasing the communication apparatus including all optional service functions, whether the functions are required by the user or not; and setting the optional service function into a valid state to use the function, or setting the function into an invalid state as required. However, when this measure is taken, all the optional service functions included in the communication apparatus are steadily charged regardless of the set state or use frequency of the optional service function, and the user also has to pay for unnecessary functions.

### BRIEF SUMMARY OF THE INVENTION

An object of the present invention is to provide a method of billing a charge for used functions of a communication apparatus, method of regulating the functions of the communication apparatus, customer center, and user system in which a service function is quickly and appropriately changed without requiring any manual operation, a charging process is finely performed in accordance with a use situation for each service function, and it is thereby possible to reduce user's expenses, shorten a time required for the change, and reduce cost and labor in the customer center.

To achieve the above-described object, the present invention is constituted as follows.

(1) There is provided a method of billing a charge of a used service function of a communication apparatus based on information exchanged via a communication network between a user system including the communication apparatus having a communication function and a customer center which supports an operation of the communication apparatus, the method comprising: causing the customer center to acquire actual-use information including at least a part of a service function group included beforehand in the communication apparatus and use amount of each service function from the user system via the communication network; causing the customer center to calculate a charge of each service function based on the actual-use information arriving from the communication apparatus, to generates a calculation result; and causing the customer center to execute a billing process of the calculation result.

(2) There is provided a method of regulating service functions of a communication apparatus based on information exchanged via a communication network between a user system including the communication apparatus having a communication function and a customer center which supports an operation of the communication apparatus, the method comprising: causing the customer center to acquire actual-use information including at least a part of a service function group included beforehand in the communication apparatus and use amount of each service function from the user system via the communication network; causing the customer center to calculate a charge of each used service function based on the actual-use information, to generates a calculation result; causing the customer center to execute a billing process of the calculation result; creating function regulation control information to regulate the service functions of the communication apparatus in accordance with a payment result of the billing process; causing the customer center to transmit the function regulation control information to the corresponding communication apparatus via the communication network.

(3) A customer center which is connected via a communication network to a user system including a communication apparatus having a communication function and which bills a charge of used service functions of the communication apparatus based on information exchanged with the user system, the customer center comprising: an actual-use information acquiring section which acquires actual-use information including at least a part of a service function group and use amount of each service function group from the communication apparatus; a charge calculating section which calculates a charge of each used service function based on the actual-use information; and a billing process section which executes a billing process of the calculated charge of each used service function with respect to the user system including the communication apparatus as a transmitter of the actual-use information.

(4) A user system which comprises a communication apparatus and which is connected to a customer center to bill a charge for a used function of the communication apparatus and to regulate/control the function via a communication network, the user system comprising: an actual-use information transmitting section which periodically transmits actual-use information including at least a part of a service function group included beforehand in the communication apparatus and use amount of each service function group to the customer center via the communication network; and a billing information receiving section which receives billing information indicating the charge of each used service function sent from the customer center via the communication network.

### BRIEF DESCRIPTION OF THE SEVERAL VIEWS OF THE DRAWING

FIG. 1 schematically shows a configuration of a support system that carries out a service function regulating method according to a first embodiment of the present invention;

FIG. 2 is a diagram showing one example of a stored content of a function information setting table disposed in a key telephone apparatus shown in FIG. 1;

FIG. 3 is a signal sequence diagram to help describe a service function regulating method in the first embodiment;

FIG. 4 is a signal sequence diagram to help describe the service function regulating method in the first embodiment;

FIG. 5 is a block diagram showing a functional configuration of each section of the system shown in FIG. 1;

FIG. 6 is a diagram showing one example of the stored content of a simultaneously connected terminal number storage table shown in FIG. 5;

FIG. 7 is a flowchart showing a procedure for processing at the key telephone apparatus in transmitting actual-use information to a customer center in the system shown in FIG. 1;

FIG. 8 is a flowchart showing the procedure for the processing at the customer center of the system shown in FIG. 1;

FIG. 9 is a flowchart showing the procedure for the processing at a personal computer for maintenance in receiving a charge billing screen from the customer center in the system show in FIG. 1;

FIG. 10 is a diagram showing one example of a display screen in the personal computer for maintenance shown in FIG. 1;

FIG. 11 is a flowchart showing a procedure for the processing at the key telephone apparatus in changing a regulated state flag of a service function in the system shown in FIG. 1;

FIG. 12 schematically shows the configuration of the support system that carries out a service function regulating method in a second embodiment of the present invention;

FIG. 13 is a diagram showing one example of the stored content of a user database shown in FIG. 12;

FIG. 14 is a signal sequence diagram to help describe the service function regulating method according to the second embodiment;

FIG. 15 is a signal sequence diagram to help describe the service function regulating method according to the second embodiment;

FIG. 16 is a block diagram showing a functional configuration of each section of the system shown in FIG. 12;

FIG. 17 is a flowchart of the procedure for processing at the customer center of the system shown in FIG. 12;

FIG. 18 is a flowchart of the procedure for processing at the key telephone apparatus in transmitting the actual-use information to the customer center in the system shown in FIG. 12;

FIG. 19 is a flowchart of the procedure for processing at the personal computer for maintenance in receiving the charge billing screen from the customer center in the system show in FIG. 12; and

FIG. 20 is a flowchart of the procedure for processing at the key telephone apparatus in changing the regulated state flag of the service function in the system shown in FIG. 12.

### DETAILED DESCRIPTION OF THE INVENTION

Embodiments of the present invention will be described hereinafter in detail with reference to the accompanying drawing.

(First Embodiment)

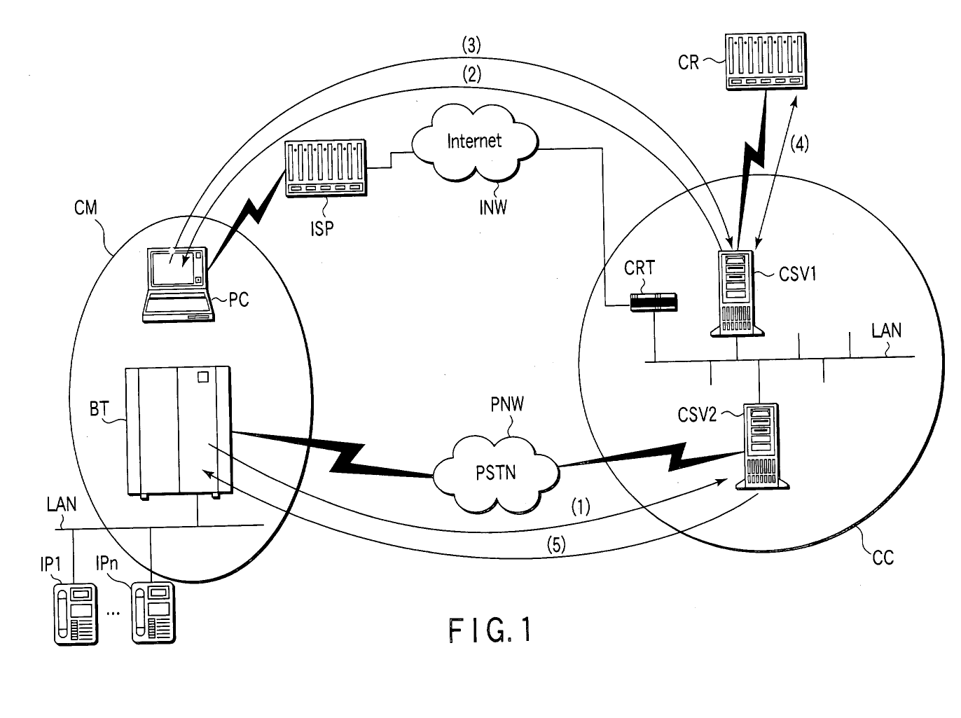

FIG. 1 schematically shows a configuration of a support system that carries out a service function regulating method in a first embodiment, wherein CM indicates a user system, CC a customer center, and CR a credit company.

The user system CM includes a key telephone apparatus BT and maintenance personal computer PC. The key telephone apparatus BT interconnects network telephone terminals (IP telephone terminals) IP1 to IPn via a LAN. A basic service function of key telephone apparatus BT is to switch among a plurality of IP telephone terminals IP1 to IPn and between those IP telephone terminals IP1 to IPn and subscribers to a public network PNW in accordance with outgoing/incoming calls. The key telephone apparatus BT further has a plurality of optional service functions related to the switching process.

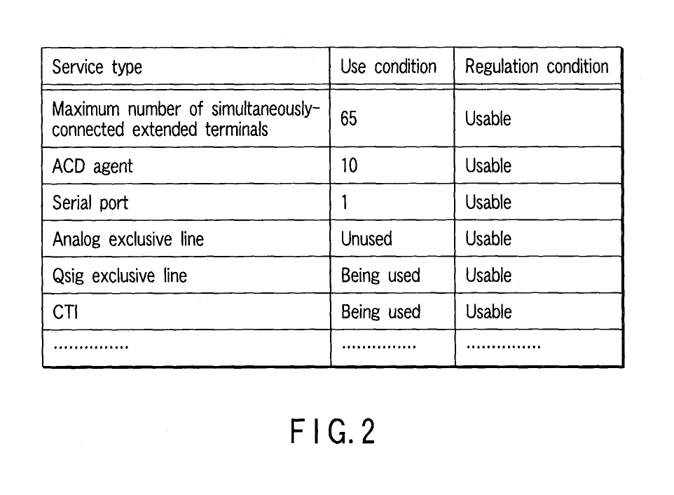

All of the programs that realize those optional service functions are stored beforehand in a program memory of the key telephone apparatus BT. Moreover, to manage setting states of the optional service functions, a function information setting table (or service execute table) is disposed in the key telephone apparatus BT. FIG. 2 shows one example of the table, and shows flags indicating a use condition and flags indicating a regulation condition stored in such a manner that the flags are associated with the respective optional service functions. When the flag indicating the regulation condition is set to “usable”, the function can be executed. On the other hand, when the flag is set to “unusable”, the function cannot be executed. Moreover, for the flag indicating the use condition, the use amount is rewritten every time in accordance with the use condition of the optional service function. In the example, the number of simultaneously connected IP telephone terminals IP1 to IPn and the number of channels for use are shown.

The maintenance personal computer PC is connected to Internet INW via a provider ISP. The computer PC is further connected to the customer center CC via the Internet INW.

The customer center CC, which includes a receiving/charging server CSV1, license server CSV2, and router CRT, connects these to one another via a LAN. The receiving/charging server CSV1, which is connected to the Internet INW via the router CRT, receives information from the maintenance personal computer PC of the user system CM. Furthermore, the receiving/charging server CSV1 is connected to the credit company CR via, for example, an exclusive line, to thereby settle the charge for the used functions with the credit company CR.

The license server CSV2 is connected to the key telephone apparatus BT of the user system CM via the public network PNW. The license server CSV2 has device identification numbers (or system IDs) uniquely assigned to the individual key telephone apparatus from the key telephone apparatus BT, function of receiving actual-use information including optional service function group of the key telephone apparatus BT and use amount, and function of sending a license code to each key telephone apparatus BT to set the regulation of the function. It is to be noted that the actual-use information is prepared based on the function information setting table (FIG. 2) disposed in the key telephone apparatus BT, and is composed of a list of already usable functions and additionally usable functions. In the license code, an instruction code for activating an additional function and a system ID are inserted.

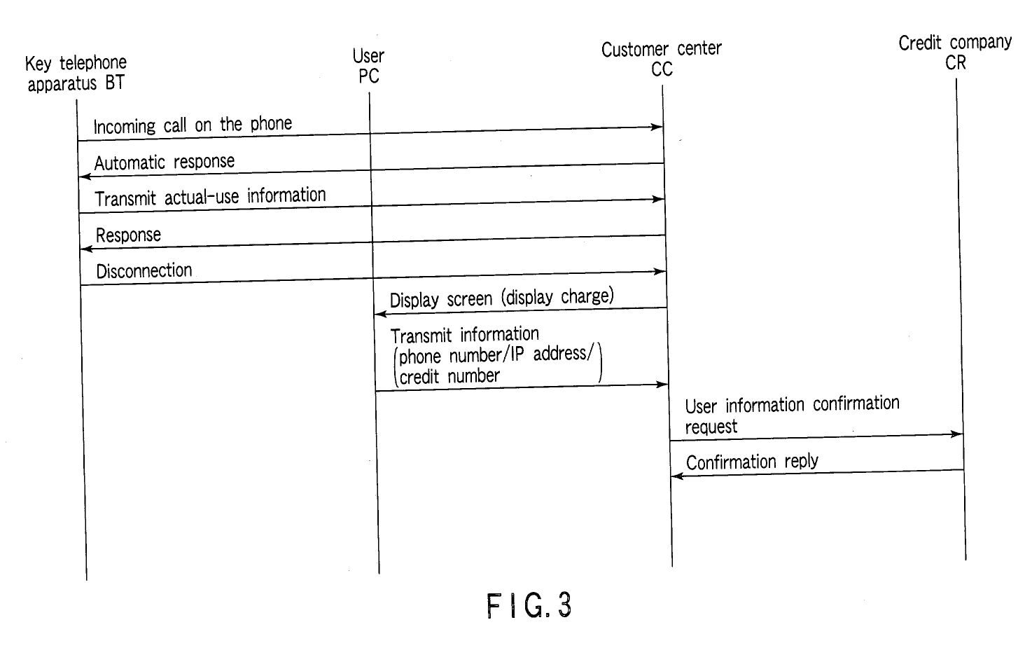

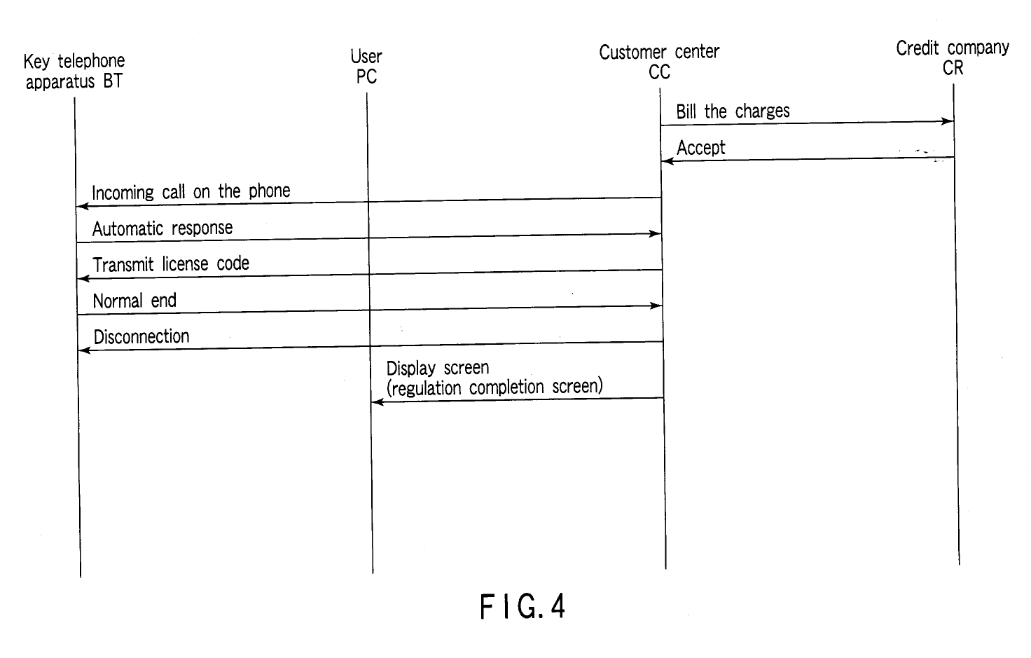

Next, a procedure for regulating the function with respect to the key telephone apparatus BT in the system will be described. FIGS. 3 and 4 are schematic sequence diagrams showing an operation of transmitting/receiving information among the maintenance personal computer PC (or user PC) of the user system CM, the key telephone apparatus BT, the customer center CC, and the credit company CR.

With elapse of a predetermined period, the key telephone apparatus BT accesses the customer center CC via the public network PNW to transmit the actual-use information to the customer center CC. At this time, the actual-use information includes the system ID assigned to the key telephone apparatus BT.

On receiving the actual-use information from the key telephone apparatus BT, the customer center CC returns information indicating the reception to the key telephone apparatus BT.

On receiving the information indicating the reception from the customer center CC, the key telephone apparatus BT disconnects a channel from the customer center CC.

Subsequently, the customer center CC judges whether or not the optional service function is being used based on the received actual-use information. When the function is not being used, the customer center judges presence/absence of an unused optional service function, or presence/absence of a used optional service function. Based on the judgment result, a charge amount is calculated corresponding to the use amount of each optional service function to prepare a detailed electronic bill. Subsequently, the detailed electronic bill is notified to the maintenance personal computer PC of the user system CM via the Internet INW.

And the user uses the maintenance personal computer PC to input necessary items related to the use of the service functions according to guidance on a screen transmitted from the customer center CC. The necessary items to be inputted include credit numbers, and telephone numbers or IP addresses allocated to the key telephone apparatus BT by the public network PNW. After having inputted these necessary items, the maintenance personal computer transmits the information to the customer center CC.

Receiving the information, the customer center CC first accesses the credit company CR via the exclusive line and inquires about credit of the user based on the user's credit number. On inquiry, the credit company CR judges the presence/absence of an account corresponding to the credit number, whether or not expiration date of the credit is within a period of validity, and whether cessation of use is set. Then, the credit company sends the reply to the customer center CC.

On the basis of the reply from the credit company CR, the customer center CC judges the credit of the user. If there is no problem, the customer center includes the detailed electronic bill and credit number in settlement request information and transmits the information to the credit company CR.

Receiving the settlement request information, the credit company CR authenticates the user on the basis of the user's credit number included in the settlement request information and determines whether to conduct a transaction. If it is possible to conduct a transaction, the credit company CR accepts the settlement of the charges on the basis of the detailed electronic bill included in the settlement request information. After finishing the acceptance of the settlement, the credit company CR sends back to the customer center CC a reply to the effect that the company CR has accepted the settlement request.

Receiving the reply to the settlement request from the credit company CR, the customer center CC creates a license code as function regulation control information on the basis of the reply result. Then, the customer center CC transmits the license code via the public network PNW to the key telephone apparatus BT. In this license code, an instruction code for setting the added optional service function to be “usable”, and an instruction code for setting the optional service function whose settlement within a given period is not confirmed to be “unusable” are inserted. At this time, the instruction codes are encrypted by system IDs received beforehand from the key telephone apparatuses BT.

Receiving the license codes from the customer center CC, the key telephone apparatuses BT decrypt the instruction codes included in the license codes using the system ID of their own. Then, according to the decrypted instruction codes, the key telephone apparatus BT re-sets the use condition flag for the corresponding function in the function information setting table to “unused”, and changes the flag for the corresponding function in the function information setting table from “unusable” to “usable” or “usable” to “unusable”. After finishing the process of setting the change of the optional service function, the key telephone apparatus BT sends back to the customer center CC the information indicating that the function changing process is completed properly.

On receiving a function change end notice from the key telephone apparatus BT, the customer center CC disconnects the channel with the key telephone apparatus BT, and transmits the information indicating the finishing of the function change process to the maintenance personal computer PC of the user owning the key telephone apparatus BT to display the information.

As a result, the functions the user wants to add are set in the key telephone apparatus BT in such a manner that they are usable. Thereafter, in the key telephone apparatus BT, the added new optional service functions can be used, and an unnecessary optional service function which has not been paid for is set to be an unusable state in the key telephone apparatus BT.

It is to be noted that the configuration of each section of the support system that realizes the above-described service function regulating method is as follows.

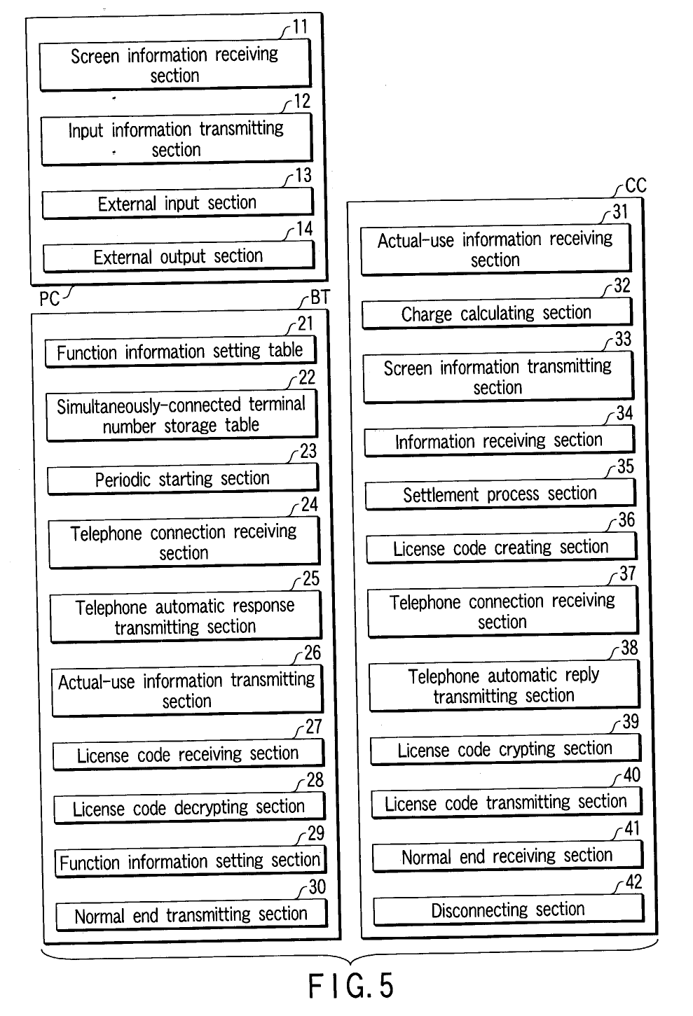

FIG. 5 is a block diagram showing a functional configuration of the maintenance personal computer PC, key telephone apparatus BT, and customer center CC.

The maintenance personal computer PC includes a screen information receiving section 11, input information transmitting section 12, external input section 13, and external output section 14.

The screen information receiving section 11 receives screen information downloaded from the customer center CC and displays them. The input information transmitting section 12 transmits request information including the credit number inputted by the user, and the telephone number or IP address of the key telephone apparatus BT to the customer center CC.

The key telephone apparatus BT include functions related to the present invention such as a function information setting table 21, simultaneously-connected terminal number storage table 22, periodic starting section 23, telephone connection receiving section 24, telephone automatic reply transmitting section 25, actual-use information transmitting section 26, license code receiving section 27, license code decrypting section 28, function information setting section 29, and normal end transmitting section 30.

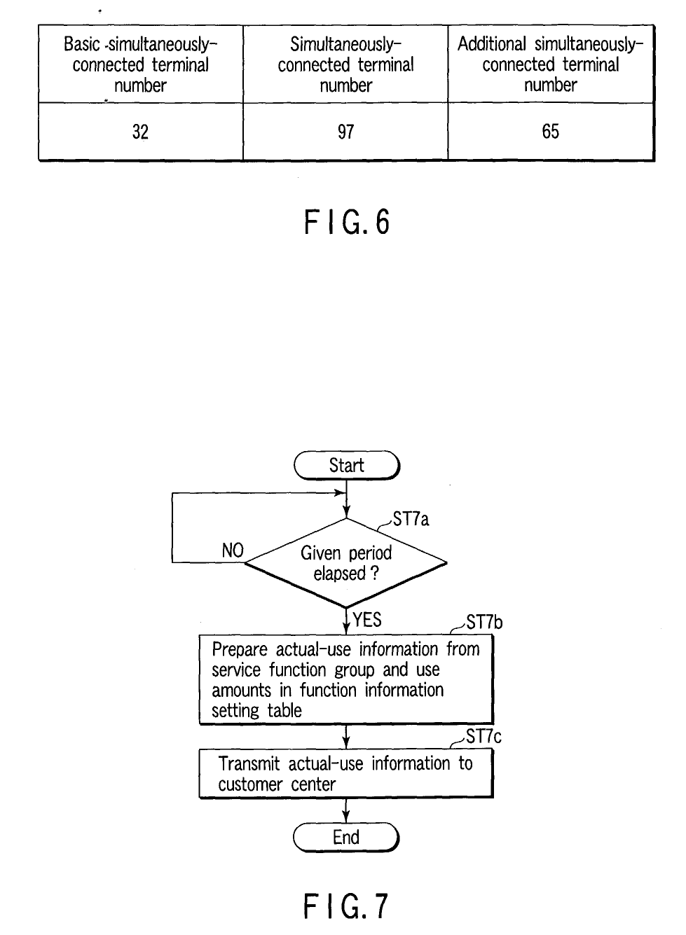

In the function information setting table 21, the service function information shown in FIGS. 2 is stored. In the simultaneously-connected terminal number storage table 22, as shown in FIG. 6, information is stored indicating a simultaneously-connected terminal number indicating the number of the connected IP telephone terminals IP1 to IPn, basic simultaneously-connected terminal number, and connection number difference (additional simultaneously-connected terminal number). It is to be noted that the basic simultaneously-connected terminal number indicates a fixed value, and the simultaneously-connected terminal number indicates a variable value in accordance with the connected states of the IP telephone terminals IP1 to IPn.

The periodic starting section 23 starts the process of each section every time the given period has elapsed.

The telephone connection receiving section 24 and telephone automatic reply transmitting section 25 receive and respond to an incoming call when the call arrives from the customer center CC. The actual-use information transmitting section 26 transmits the actual-use information including the optional service function group and use amounts stored in the function information setting table 21 based on the control by the periodic starting section 23.

The license code decrypting section 27 receives the license code arriving from the customer center CC. The license code decrypting section 28 uses its own system ID to decrypt the license code received by the license code receiving section 27. The function information setting section 29 sets the flag indicating the regulation condition of the designated function to be “usable” or “unusable” in accordance with the decoded license code.

The customer center CC includes an actual-use information receiving section 31, charge calculating section 32, screen information transmitting section 33, information receiving section 34, settlement process section 35, license code creating section 36, telephone connection receiving section 37, telephone automatic reply transmitting section 38, license code encrypting section 39, license code transmitting section 40, normal end receiving section 41, and disconnecting section 42.

Among the sections, the actual-use information receiving section 31 receives the actual-use information arriving from the key telephone apparatus BT. The charge calculating section 32 calculates the use charge for each optional service function.

The screen information transmitting section 33 transmits screen information including the use amount and charge for each optional service function to the user's maintenance personal computer PC. The information receiving section 34 receives information necessary for the settlement process of the use charge including the credit number sent from the maintenance personal computer PC and the phone number of the key telephone apparatus BT.

The settlement process section 35 executes the settlement process for charging the use charge for each optional service function to the user's account with the credit company CR based on the credit number received by the information receiving section 34.

The license code creating section 36 creates the license code for setting the use flag of the optional service function to be “usable”, “unusable” based on the settlement process result by the settlement process section 35.

The telephone connection receiving section 37 and telephone automatic reply transmitting section 38 receive and respond to the incoming call, when the call arrives from the key telephone apparatus BT.

The license code encrypting section 39 and license code transmitting section 40 use the system IDs of the key telephone apparatuses BT to encrypt the license codes, and transmit the encrypted license codes to the key telephone apparatuses BT. The normal end receiving section 41 receives normal end signals sent from the key telephone apparatuses BT after the function adding process, and notifies the maintenance personal PC that the normal end signals have been received.

Thereafter, the disconnecting section 42 disconnects a communication link between the key telephone apparatus BT and customer center CC.

FIG. 7 is a flowchart showing an operation of the key telephone apparatus BT. The procedure shown in steps ST7a to ST7c is followed to perform a process operation for informing the customer center CC of the use amount of each optional service function.

The key telephone apparatus BT judges whether or not the given period has elapsed after start (step ST7a). When the given period elapses (Yes), the key telephone apparatus creates the actual-use information from the service function group and use amounts in the function information setting table 21 (step ST7b), accesses the customer center CC via the public network PNW, and transmits the actual-use information (step ST7c).

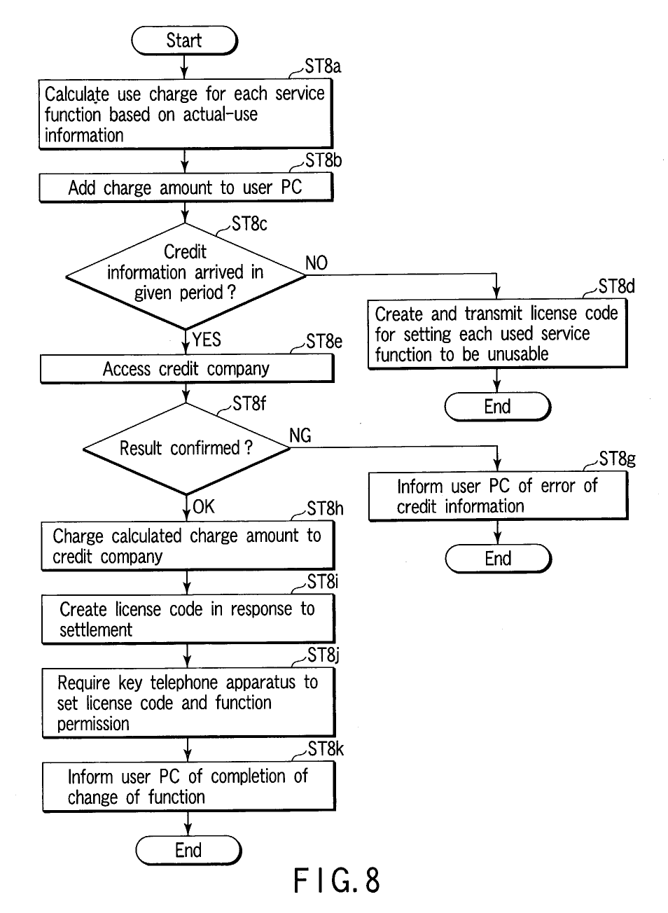

FIG. 8 is a flowchart showing the operation of the customer center CC.

That is, on receiving the actual-use information from the key telephone apparatus BT, the customer center CC calculates the use charge of each optional service function, that is, the charge amount based on the actual-use information (step ST8a), and notifies the user's maintenance personal computer PC of the charge amount together with the optional service function (step ST8b). Moreover, it is monitored whether or not credit information for the charge amount notified from the maintenance personal computer PC arrives within the given period (step ST8c). Here, when the credit information does not arrive (No), the customer center CC prepares the license code for setting each already used service function to be “unusable”, and transmits the code to the corresponding key telephone apparatus BT (step ST8d).

On the other hand, when the credit information arrives (Yes), the customer center CC accesses the credit company CR (step ST8e), and confirms the credit information (step ST8f). Subsequently, if impossible (NG), the center notifies the maintenance personal computer PC as a requester of an error of the credit information (step ST8g).

On the other hand, if possible (OK), the customer center CC transmits settlement request information of the charge amount calculated beforehand to the credit company CR (step ST8h). Subsequently, when a reply indicating the acceptance is returned to the settlement request from the credit company CR, the customer center CC creates the license code based on the settlement result included in the reply (step ST8i), and sends this license code and a request for setting the regulated flag of the optional service function to be possible/impossible to the key telephone apparatus BT (step ST8j).

Subsequently, when the function setting ends in the key telephone apparatus BT, the customer center CC notifies the user's maintenance personal computer PC of the completion of the function setting (step ST8k).

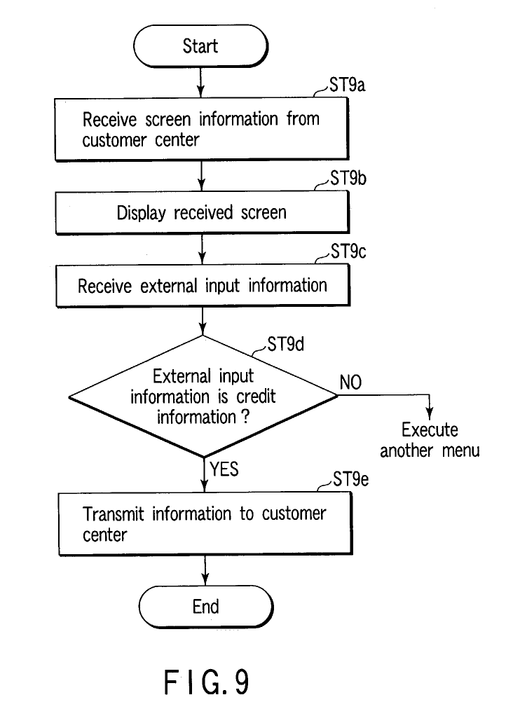

It is to be noted that FIG. 9 is a flowchart showing the procedure for the processing at the maintenance personal computer PC.

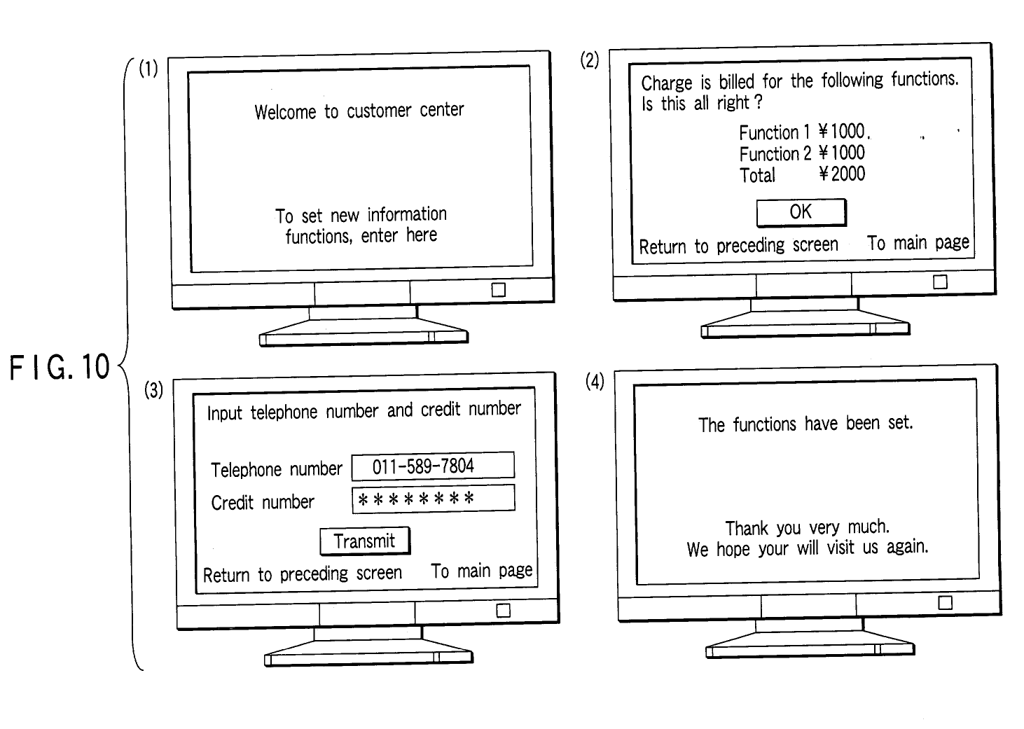

While power supply is ON, the maintenance personal computer PC receives the screen information from the customer center CC (step ST9a), and performs screen display as shown in FIGS. 10(1) and 10(2) (step ST9b). Here, the user uses the maintenance personal computer PC to click “OK” in the screen shown in FIG. 10(2). Then, the maintenance personal computer PC shifts to step ST9d from step ST9c to monitor whether or not the phone and credit numbers are inputted. Here, when the phone and credit numbers are inputted in the screen of FIG. 10(3), and thereafter “transmit” is clicked, the maintenance personal computer PC transmits input information to the customer center CC (step ST9e). On the other hand, when “return to preceding screen” or “to main page” is clicked in the screen of FIG. 10(3), the maintenance personal computer PC executes the process in another menu.

Thereafter, when the function setting change process of the key telephone apparatus BT ends, the customer center CC sends the screen information shown in FIG. 10(4) to the maintenance personal computer PC.

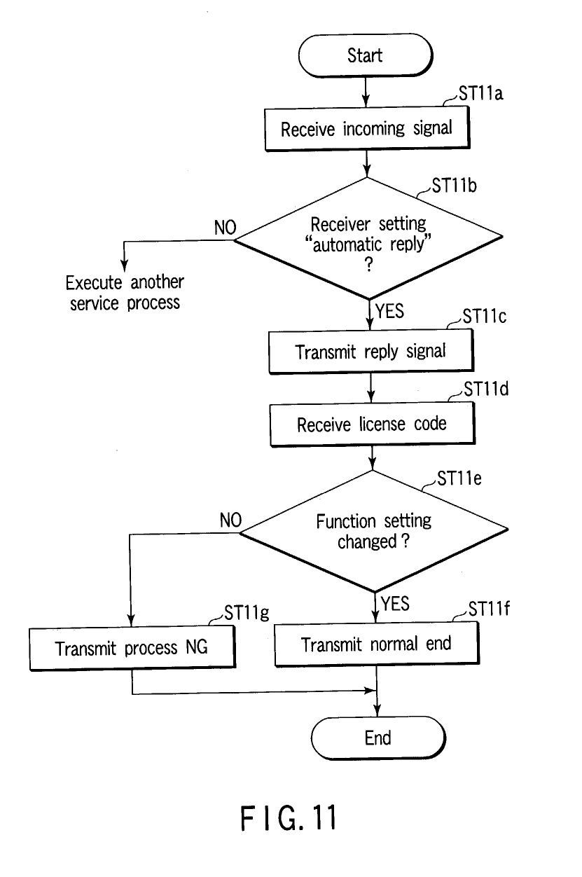

FIG. 11 is a flowchart showing the procedure for the processing at the key telephone apparatus BT in changing the regulated state flag of the service function.

On receiving an incoming signal from the customer center CC via the public network PNW (step ST11a), the key telephone apparatus BT judges whether or not receiver setting is “automatic reply” (step ST11b). Here, when the “automatic reply” is not set (No), the key telephone apparatus BT executes another service process.

On the other hand, when “automatic reply” is set (Yes), the key telephone apparatus BT transmits a reply signal to the incoming signal to the customer center CC (step ST11c), receives the license code from the customer center CC (step ST11d), and judges whether or not the function setting can be changed based on the license code (step ST11e).

Subsequently, when the function setting can be changed (Yes), the key telephone apparatus BT transmits the information indicating normal end to the customer center CC (step ST11f). On the other hand, when the function setting cannot be changed (No), the key telephone apparatus BT transmits the information indicating process NG to the customer center CC (step ST11g).

As described above, according to the service function regulating method of the first embodiment, a series of procedures including: the calculating step of the use charge of each optional service function of the key telephone apparatus BT; and billing step to the user; or the regulating step of the optional service function in accordance with user's payment for each optional service function within the given period; and further the settlement step of the use charge of each optional service function are all automatically performed via communication networks such as the Internet INW and public network PNW without requiring any manual operation. Therefore, the traveling and manual function change work by the maintenance man, and billing work of expenses by the billing worker are unnecessary. For the user, it is possible to reduce the cost steadily required for the optional services having low use frequency or unused channel. On the other hand, for the customer center CC, it is possible to largely reduce the labor and cost necessary for the billing process of each optional service function in accordance with the use condition.

Moreover, in the customer center CC, based on the payment result of the billing of the use charge for each optional service function in the key telephone apparatus BT, it can be judged whether or not the user requires each optional service function. Thereby, the optional service function of the key telephone apparatus BT can be regulated so that only the truly necessary optional service function can be used.

Moreover, when the license code is transferred to the key telephone apparatus BT from the customer center CC, the code is encrypted by the system ID of the key telephone apparatus BT. Therefore, when the license code is transferred to the different key telephone apparatus BT by mistake, or even when another user intentionally misappropriates the license code addressed to another key telephone apparatus BT to perform the function setting of the own key telephone apparatus BT, an erroneous or illegal function setting process can be prevented from being performed.

Furthermore, when the user pays for the regulated optional service function, the customer center CC immediately sets the regulated optional service function of the key telephone apparatus BT to the usable state via the public network PNW. Also for this respect, the traveling and manual function change work by the maintenance man are unnecessary. Therefore, for the user, it is possible to use the additional service function of the own key telephone apparatus BT in a short time. On the other hand, for the customer center, it is possible to largely reduce the labor and cost necessary for providing the additional service function.

Moreover, in the first embodiment, for example, when the present invention is applied to an IP telephone system connected to the IP telephone terminal, a difference between the maximum number of connectable terminals steadily billed for the charge and the number of terminals actually connected to the communication apparatus is notified as the actual-use information to the customer center CC from the key telephone apparatus BT. Therefore, the customer center CC can bill only the use charge from which a charge for the terminal number difference notified from the key telephone apparatus BT is subtracted, that is, only the use charge for the number of the IP telephone terminals IP1 to IPn actually connected to the key telephone apparatus BT. Therefore, the user pays the use charge for the IP telephone terminals IP1 to IP4 connected to the key telephone apparatus BT, and does not have to pay the use charge for the unused IP telephone terminals IP5 to IPn, and this can reduce the expense burden.

It is to be noted that in the first embodiment the user confirms the use charge of each optional service function and inputs the credit number. Alternatively, the customer center CC may transmit the screen information on the unused or regulated optional service function in addition to the use charge of each optional service function to the maintenance personal computer PC. After selecting the optional service function to be used on a user side, the credit number may also be inputted.

Additionally, various optional service functions of the key telephone apparatus BT which have been additionally set as described above can be executed as follows.

That is, for example, when ACD agent use requests first arrive from the IP telephone terminals IP1 to IPn, the function information setting table 21 is accessed. It is judged whether the function is “usable” or “unusable” from the regulated state flag corresponding to the ACD agent. Subsequently, with “usable”, the request is accepted to execute the corresponding process. On the other hand, with “unusable”, service rejection is returned to the IP telephone terminals IP1 to IPn which are requesters.

(Second Embodiment)

A second embodiment of the service function regulating method according to the present invention comprises: directly accesses the customer center by the user system; and using a user database disposed in the customer center to perform the billing process of the use charge of each optional service function with respect to the key telephone apparatus of the user system and service function regulating process.

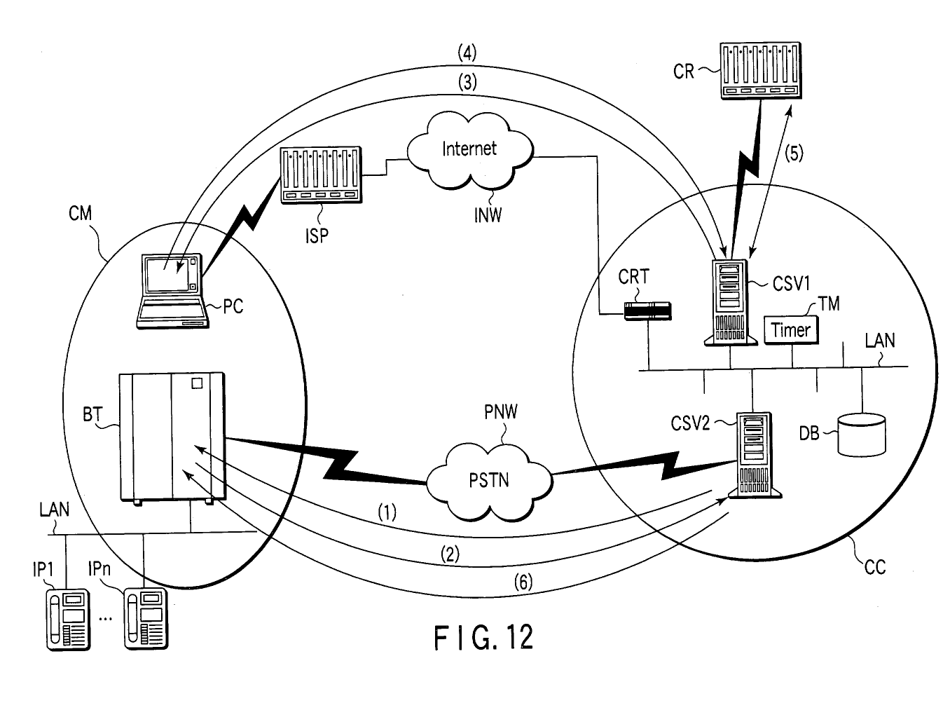

FIG. 12 schematically shows the configuration of a support system for realizing the second embodiment. It is to be noted that in FIG. 12, the same parts as those in FIG. 1 are indicated by the same reference numerals, and a detailed description thereof is omitted.

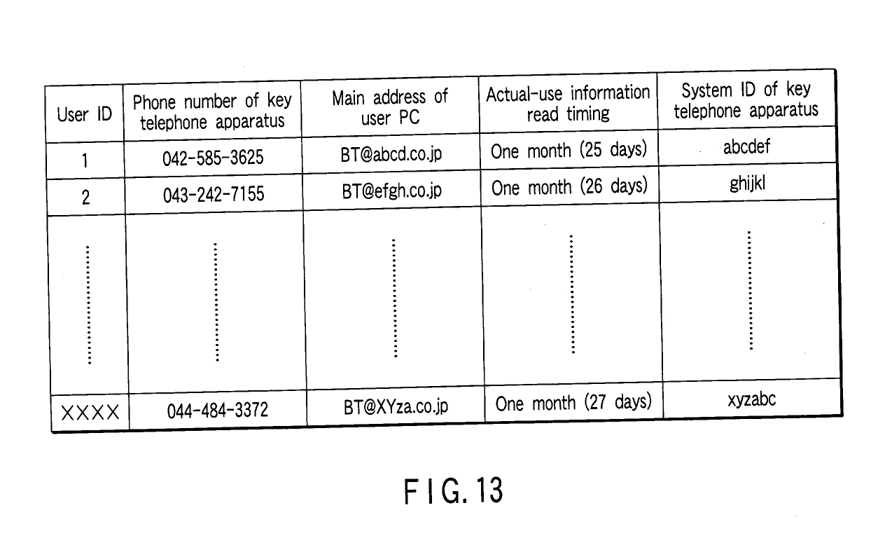

In the customer center CC, a user database DB and timer TM are disposed. In the user database DB, as shown in FIG. 13, in association with the individual identification numbers (user IDs) assigned to the respective users, the system IDs of the key telephone apparatuses BT owned by the users, phone numbers of the key telephone apparatuses BT, and mail addresses of the maintenance personal computers PC, and timings of reading the actual-use information are stored.

The receiving/charging server CSV1 and license server CSV2 of the customer center CC compare a date/time measured by the timer TM with the read timing of the actual-use information in the user database DB, and reads the phone number of the key telephone apparatus BT owned by the user, system ID, and mail address of the maintenance personal computer PC based on the comparison result. Subsequently, the read information is used to access the key telephone apparatus BT, bill the use charge of each optional service function, and transmit the license code.

Next, the procedure for regulating the service function of the key telephone apparatus BT in the system will be described.

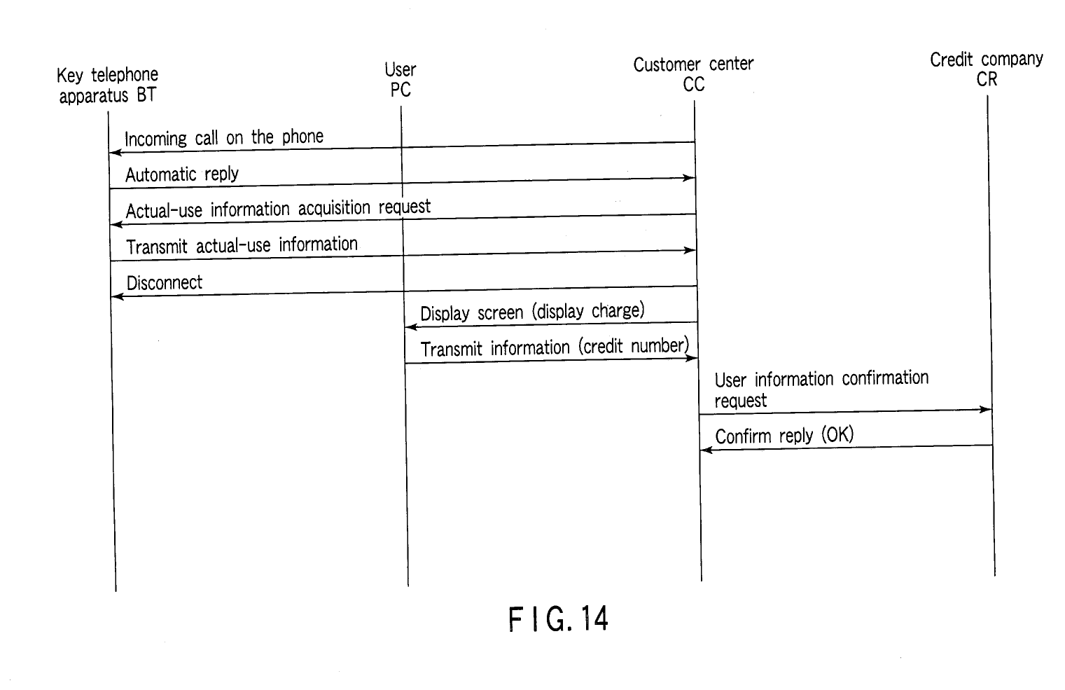

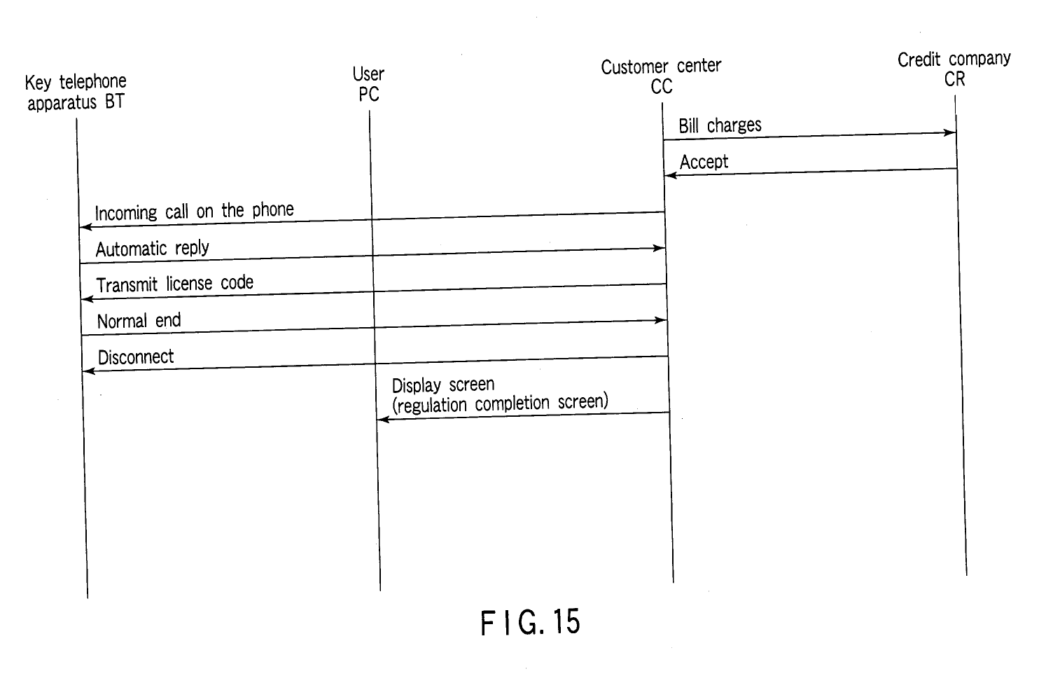

FIGS. 14 and 15 are sequence diagrams showing the operation of transmitting/receiving the information among the maintenance personal computer PC (or user PC) of the user system CM, key telephone apparatus BT, customer center CC, and the credit company CR.

The customer center CC compares the date/time measured by the timer TM with the date/time to acquire the actual-use information stored in the user database DB (read timing) to judge whether or not the dates/times agree with each other, accesses the corresponding key telephone apparatus BT via the public network PNW based on the judgment result, and transmits an actual-use information acquisition request to the key telephone apparatus BT.

On receiving the actual-use information acquisition request from the customer center CC, the key telephone apparatus BT prepares the actual-use information, and transmits the actual-use information to the customer center CC.

On receiving the actual-use information from the key telephone apparatus BT, the customer center CC returns the information indicating the reception to the key telephone apparatus BT.

On receiving the information indicating the reception from the customer center CC, the key telephone apparatus BT disconnects the channel with the customer center CC.

Subsequently, the customer center CC judges whether or not the optional service function is being used based on the received actual-use information. When the function is not being used, the customer center judges the presence/absence of the unused optional service function, or the presence/absence of the used optional service function. Based on the judgment result, the charge amount is calculated corresponding to the use amount of each optional service function to prepare the detailed electronic bill. Subsequently, based on the user's mail address stored in the user database DB, the maintenance personal computer PC of the user system CM is accessed via the Internet INW to transmit the prepared detailed electronic bill to the maintenance personal computer PC of the user system CM.

And the user uses the maintenance personal computer PC to input the necessary items related to the use of the optional service function according to the guidance on the screen transmitted from the customer center CC. Necessary items to be inputted include the credit number. After having inputted these necessary items, the personal computer transmits these information to the customer center CC.

Receiving the information, the customer center CC first accesses the credit company CR via the exclusive line and inquires about the credit of the user based on the user's credit number. On inquiry, the credit company CR judges whether the account corresponding to the credit number is present, whether the expiration date of the credit is within the period of validity, and whether the cessation of use is set. Then, the credit company sends the reply to the customer center CC.

On the basis of the reply from the credit company CR, the customer center CC judges the credit of the user. If there is no problem, the customer center includes the detailed electronic bill and credit number in the settlement request information to transmit the information to the credit company CR.

Receiving the settlement request information, the credit company CR authenticates the user based on the user's credit number included in the settlement request information and judges whether to conduct the transaction. If it is possible to conduct the transaction, the credit company accepts the settlement of the charges based on the detailed electronic bill included in the settlement request information. Thereafter, after finishing the acceptance of the settlement, the credit company sends back to the customer center CC which is the requester a reply to the effect that the company has accepted the settlement request.

Receiving the reply to the settlement request from the credit company CR, the customer center CC creates the license code which is function regulation control information based on the reply result. Then, the customer center transmits the license code to the key telephone apparatus BT of the user system CM via the public network PNW. In this license code, the instruction code for setting the added optional service function to be “usable”, and the instruction code for setting the optional service function whose settlement within the given period is not confirmed to be “unusable” are inserted. At this time, the instruction codes are encrypted by the system IDs read from the user database DB.

Receiving the license codes from the customer center CC, the key telephone apparatuses BT first decrypt the instruction codes included in the license codes using the system ID of their own. Then, according to the decrypted instruction codes, the key telephone apparatus BT resets the use condition flag for the corresponding optional service function in the function information setting table to “unused”, and changes the flag in the regulation condition to “usable” from “unusable” or to “unusable” from “usable”. After finishing the process of setting the change of the optional service function, the key telephone apparatus BT sends back to the customer center CC the information to the effect that the function changing process is completed properly.

On receiving the function change end notice from the key telephone apparatus BT, the customer center CC disconnects the channel with the key telephone apparatus BT, and transmits the information indicating the finishing of the function change process to the maintenance personal computer PC of the user owning the key telephone apparatus BT to display the information.

As a result, the optional service functions desired to be added by the user are set to be in the usable state in the key telephone apparatus BT, and the unnecessary optional service function which is not paid for is set to be in the unusable state in the key telephone apparatus BT.

It is to be noted that the configuration of each section of the support system that realizes the above-described service function regulating method is as follows.

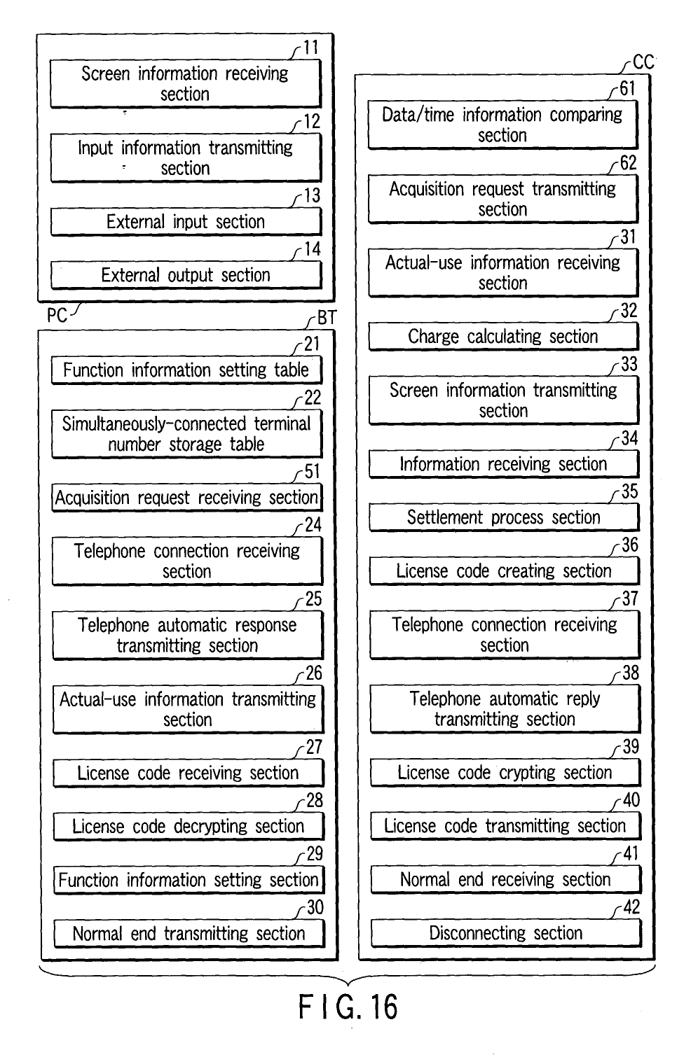

FIG. 16 is a block diagram showing the functional configuration of the maintenance personal computer PC, key telephone apparatus BT, and customer center CC. It is to be noted that In FIG. 16 the same parts as those in FIG. 5 are indicated by the same reference numerals, and the detailed description thereof is omitted.

The key telephone apparatus BT newly includes an acquisition request receiving section 51 instead of the periodic starting section 23. The acquisition request receiving section 51 receives the actual-use information acquisition request arriving from the customer center CC. Subsequently, the actual-use information transmitting section 26 transmits the actual-use information including the optional service function group and use amounts stored in the function information setting table 21 based on the actual-use information acquisition request received from the acquisition request receiving section 51.

The customer center CC further includes a date/time information comparing section 61 and acquisition request transmitting section 62. The date/time information comparing section 61 compares the date/time measured by the timer TM with the date/time stored in the user database DB to judge whether or not the dates/times agree with each other.

The acquisition request transmitting section 62 transmits the actual-use information acquisition request to the corresponding key telephone apparatus BT via the public network PNW based on the judgment result by the date/time information comparing section 61.

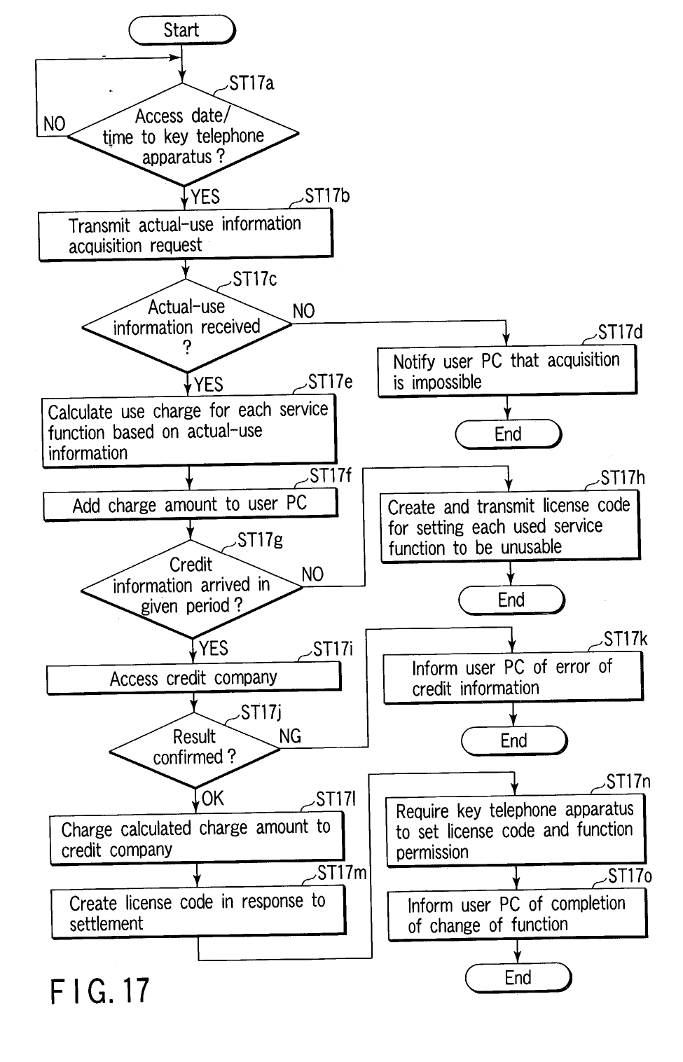

FIG. 17 is a flowchart showing the operation of the customer center CC.

The customer center CC first compares the date/time measured by the timer TM with the actual-use information read date/time stored in the user database DB to judge whether or not it is an access date/time to the key telephone apparatus BT (step ST17a). Subsequently, at the access date/time (Yes), the customer center CC reads the phone number of the corresponding key telephone apparatus BT from the user database DB, accesses the key telephone apparatus BT via the public network PNW based on the read phone number, and transmits the actual-use information acquisition request to the key telephone apparatus BT (step ST17b).

Subsequently, the customer center CC judges whether or not the actual-use information has arrived from the accessed key telephone apparatus BT within the given period (step ST17c). Subsequently, when the actual-use information does not arrive in the given period (No), the customer center CC disconnects the channel with the corresponding key telephone apparatus BT, and notifies the maintenance personal computer PC of the user owning the key telephone apparatus BT that the actual-use information cannot be acquired (step ST17d). In this case, the maintenance personal computer PC is accessed via the Internet INW based on the mail address of the maintenance personal computer PC stored in the user database DB.

On the other hand, when the actual-use information arrives within the given period (Yes), the customer center CC calculates the use charge of each service function, that is, the charge amount based on the actual-use information (step ST17e), and notifies the user's maintenance personal computer PC of the charge amount together with the service function (step ST17f). Subsequently, it is monitored whether or not the credit information for the charge amount notified from the maintenance personal computer PC arrives within the given period (step ST17g). Here, when the credit information does not arrive (No), the customer center CC creates the license code for setting each already used optional service function to be “unusable”, and transmits the code to the corresponding key telephone apparatus BT (step ST17h).

On the other hand, when the credit information arrives (Yes), the customer center CC accesses the credit company CR (step ST17i), and confirms the credit information (step ST17j). Subsequently, if impossible (NG), the center notifies the maintenance personal computer PC as the requester of the error of the credit information (step ST17k).

On the other hand, if possible (OK), the customer center CC transmits the settlement request information of the charge amount calculated beforehand to the credit company CR (step ST17l). Subsequently, when the reply indicating the acceptance is returned to the settlement request from the credit company CR, the customer center CC creates the license code based on the settlement result included in the reply (step ST17m), and sends this license code and request for setting the function to be usable or unusable to the key telephone apparatus BT (step ST17n).

Subsequently, when the function setting ends in the key telephone apparatus BT, the customer center CC notifies the user's maintenance personal computer PC of the completion of the function setting (step ST17o).

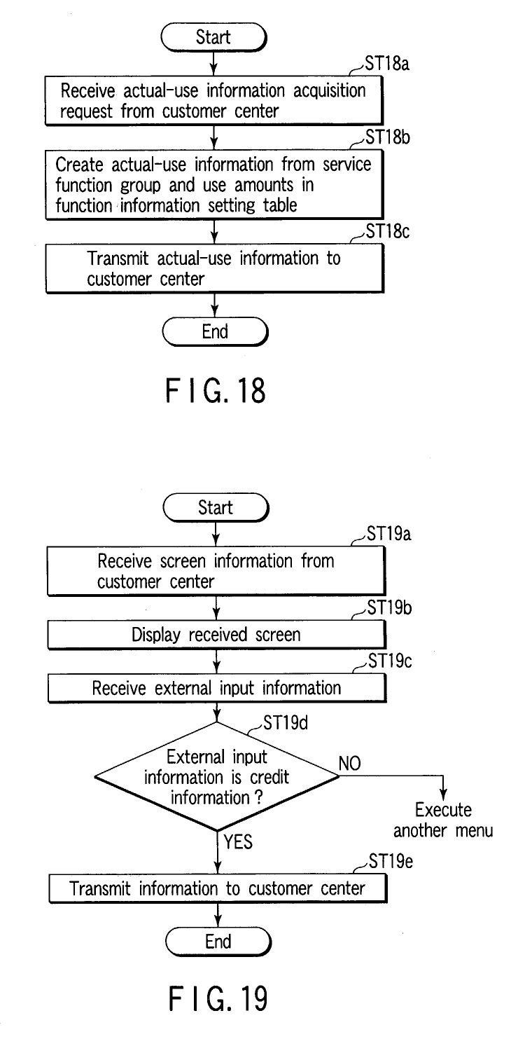

FIG. 18 is a flowchart showing the operation of the key telephone apparatus BT. Following the procedure of steps ST18a to ST18c, the process operation of notifying the customer center CC of the use amount of each optional service function is performed.

On receiving the actual-use information acquisition request from the customer center CC (step ST18a), the key telephone apparatus BT creates the actual-use information from the optional service function group and use amounts in the function information setting table 21 (step ST18b), accesses the customer center CC via the public network PNW, and transmits the actual-use information (step ST18c).

It is to be noted that FIG. 19 is a flowchart showing the detailed process procedure of the user's maintenance personal computer PC.

That is, on receiving the screen information from the customer center CC (step ST19a), the maintenance personal computer PC displays the screens as shown in FIGS. 10(1) and 10(2) (step ST19b). Here, the user uses the maintenance personal computer PC to click “OK” in the screen shown in FIG. 10(2). Then, the maintenance personal computer PC shifts to step ST19d from step ST19c to monitor whether or not the phone and credit numbers are inputted. Here, when the phone and credit numbers are inputted in the screen of FIG. 10(3), and thereafter “transmit” is clicked, the maintenance personal computer PC transmits the input information to the customer center CC (step ST19e). On the other hand, when “return to the preceding screen” or “to main page” is clicked in the screen of FIG. 10(3) in the step ST19d, the maintenance personal computer PC executes the process in the other menu.

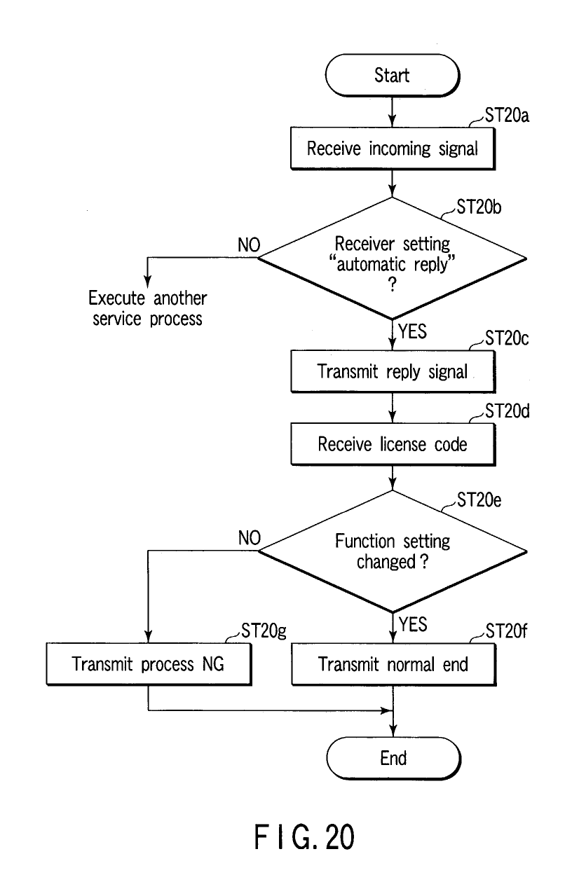

FIG. 20 is a flowchart showing the procedure for the processing at the key telephone apparatus BT in changing the regulated state flag of the service function.

On receiving the incoming signal from the customer center CC via the public network PNW (step ST20a), the key telephone apparatus BT judges whether or not the receiver setting is “automatic reply” (step ST20b). Here, when the “automatic reply” is not set (No), the key telephone apparatus BT executes the other service process.

On the other hand, when the “automatic reply” is set (Yes), the key telephone apparatus BT transmits the reply signal to the incoming signal to the customer center CC (step ST20c), receives the license code from the customer center CC (step ST20d), and judges whether or not the function setting can be changed based on the license code (step ST20e).

Subsequently, when the function setting can be changed (Yes), the key telephone apparatus BT transmits the information indicating normal end to the customer center CC (step ST20f). On the other hand, when the function setting cannot be changed (No), the key telephone apparatus BT transmits the information indicating the process NG to the customer center CC (step ST20g).

As described above, according to the service function regulating method of the second embodiment, in the same manner as in the first embodiment, the series of procedures including: the calculating step of the use charge of each optional service function of the key telephone apparatus BT; and the billing step to the user; or the regulating step of the optional service function in accordance with the user's payment for each optional service function within the given period; and further the settlement step of the use charge of each optional service function are all automatically performed via the communication networks such as the Internet INW and public network PNW without requiring any manual operation. Therefore, for the user, it is possible to reduce the cost steadily required for the optional services having the low use frequency or unused channels. On the other hand, for the customer center CC, it is possible to largely reduce the labor and cost necessary for the billing process of each optional service function in accordance with the use condition.

Moreover, since the license code is encrypted by the system ID of the key telephone apparatus BT stored in the user database DB, and transferred to the key telephone apparatus BT, the erroneous or illegal function adding process can be prevented from being performed.

Furthermore, in the second embodiment, the user information accumulated/managed in the user database DB is used to judge the possibility/impossibility of the communication between the customer center CC and key telephone apparatus BT, the billing of the use charge of each optional service function, and regulating of the optional service function in accordance with the payment to the billing. Therefore, it is unnecessary to dispose the periodic starting section in the key telephone apparatus BT. The key telephone apparatus BT does not need to access the customer center CC. Thereby, the process load of the key telephone apparatus BT can be reduced and the cost can be reduced.

(Other Embodiments)

In the second embodiment, the example in which the user database DB is disposed in the customer center CC has been described. However, the user database DB may also be disposed in a third organization other than the customer center CC.

Moreover, in the respective embodiments, the user transmits the credit number. However, the present invention is not limited to this. The credit number may be associated with the user ID and stored beforehand in the user database DB. The customer center CC may access the user database DB to acquire the credit number. In this case, the user's credit number may be transmitted, only when the user information is registered in the user database DB. As a result, there is no fear that the credit number is peeped at on the communication network at a transmission time, and security can be enhanced.

Furthermore, in the respective embodiments, the credit number notified from the user is used to perform the automatic settlement with the credit company CR. However, the present invention is not limited to this. When the user pays the use charge of each optional service function to the designated bank, the customer center CC may bill the use charge of each service function to the bank.

Additionally, in the embodiments, the program for executing various optional service functions is stored beforehand in the key telephone apparatus BT, the usable/unusable state is managed by the flag in the function information setting table 21, and the customer center CC sends the license code to change the flag to be “usable” so that the function addition is set. However, the present invention is not limited to this. The program for executing the function may be downloaded to the key telephone apparatus BT from the customer center CC and executed.

Furthermore, in the embodiments, the customer center CC sends only the license code corresponding to the function to be added to the key telephone apparatus BT, and the flag of the additional function is set to be “usable” by the license code. However, the license codes of all the functions including the license code corresponding to the additional function are sent. The function information setting table 21 of the key telephone apparatus BT may totally be rewritten by the license codes.

Additionally, the procedure or content of the function setting, the constitution or operation content of the support system, and the types of the communication apparatuses such as the key telephone apparatus may variously be modified and implemented without departing from the scope of the present invention.

What is claimed is:

1. A method of billing a charge for used functions of a communication apparatus having a communication function in a user system that includes the communication apparatus in accordance with information being communicated through a communication network, between the user system and a customer center that supports an operation of the communication apparatus, the method comprising:
causing the customer center to acquire an actual-use information including at least a part of a service function group disposed beforehand in the communication apparatus and use amount of each service function, from the user system via the communication network;
causing the customer center to calculate a charge of the used service function based on the actual-use information, to generate a calculation result; and
causing the customer center to execute a billing process of the calculation result.

2. The method of billing the charge for the used functions of the communication apparatus according to claim 1, wherein the step of acquiring the actual-use information comprises: receiving the actual-use information periodically transmitted from the communication apparatus.

3. The method of billing the charge for the used functions of the communication apparatus according to claim 1, wherein the customer center comprises:
a user database in which subscriber information assigned to the communication apparatus from the communication network, confidential apparatus identification information assigned beforehand to the communication apparatus, and date/time information for acquiring at least the part of the service function group and use amount of each service function from the communication apparatus are associated with individual identification information assigned beforehand to the user system and stored; and
a timer, and
the step of acquiring the actual-use information comprises: comparing present date/time information obtained by the timer with the date/time information stored in the user database; and accessing the corresponding communication apparatus via the communication network based on the comparison result to acquire the actual-use information.

4. A method of regulating service functions of a communication apparatus having a communication function in a user system that includes the communication apparatus in accordance with information being communicated through a communication network, between the user system and a customer center that supports an operation of the communication apparatus, the method comprising:
causing the customer center to acquire an actual-use information including at least a part of a service function group disposed beforehand in the communication apparatus and use amount of each service function, from the user system via the communication network;
causing the customer center to calculate a charge of each used service function based on the actual-use information, to generate a calculation result;
causing the customer center to execute a billing process of the calculation result;
causing the customer center to create function regulation control information to regulate service functions of the communication apparatus in accordance with a payment result with respect to the billing step; and
causing the customer center to transmit the function regulation control information to the corresponding communication apparatus via the communication network.

5. The function regulating method of the communication apparatus according to claim 4, wherein the step of acquiring the actual-use information comprises: receiving the actual-use information periodically transmitted from the communication apparatus.

6. The function regulating method of the communication apparatus according to claim 4, wherein the customer center comprises: a user database in which subscriber information assigned to the communication apparatus from the communication network, confidential apparatus identification information assigned beforehand to the communication apparatus, and date/time information for acquiring at least the part of the service function group and use amount of each service function from the communication apparatus are associated with individual identification information assigned beforehand to the user system and stored; and a timer, and
the step of acquiring the actual-use information comprises: comparing present date/time information obtained by the timer with the date/time information stored in the user database; and accessing the corresponding communication apparatus via the communication network based on the comparison result to acquire the actual-use information.

7. The function regulating method of the communication apparatus according to claim 4, wherein the charge amount comprises a plurality of terminals connected to the communication apparatus,
the step of acquiring the actual-use information comprises: acquiring the actual-use information together with terminal use information including information indicating the plurality of terminals and a difference between the number of terminals connected to the communication apparatus and the maximum number of connectable terminals in the communication apparatus, and
the step of performing the billing process comprises: calculating the use charge of each terminal based on the terminal use information.

8. A customer center which is connected to a user system including a communication apparatus having a communication function via a communication network, and which bills a charge of used service functions of the communication apparatus based on information exchanged with the user system, the customer center comprising:
an actual-use information acquiring section which acquires an actual-use information including at least a part of a service function group and use amount of each service function group from the communication apparatus;
a charge calculating section which calculates a charge of each used service function based on the actual-use information generates a calculation result; and
a billing process section which executes a billing process of the calculation result.

9. The customer center according to claim 8, wherein the actual-use information acquiring section receives the actual-use information periodically transmitted from the communication apparatus.

10. The customer center according to claim 8, further comprising:
a user database in which subscriber information assigned to the communication apparatus from the communication network, confidential apparatus identification information assigned beforehand to the communication apparatus, and date/time information for acquiring at least the part of the service function group and use amount of each service function from the communication apparatus are associated with individual identification information assigned beforehand to the user system and stored;
a timer; and
a comparing section which compares present date/time information obtained by the timer with the date/time information stored in the user database,
wherein the actual-use information acquiring section accesses the corresponding communication apparatus via the communication network based on the comparison result to acquire the actual-use information from the communication apparatus.

11. The customer center according to claim 8, further comprising:
a creating section which creates function regulation control information to perform a function regulating process of the communication apparatus based on a payment result with respect to the billing process by the billing process section; and
a function regulation control information transmitting section which transmits the function regulation control information to the corresponding communication apparatus via the communication network.

12. The customer center according to claim 8, which can be connected to a charge settlement organization via the communication network, and
which further comprises:
an account identification information receiving section which receives user's account identification information sent from the user system which is notified a billing process result by the billing process section; and
a settlement process section which executes a settlement process to charge the charge of each used service function to a user's account with the charge settlement organization via the communication network based on the account identification information.

13. The customer center according to claim 11, wherein the communication apparatus transmits the actual-use information and an apparatus identification information which is assigned beforehand, to use in a decode process,
the actual-use information acquiring section receives the apparatus identification information together with the service function group and use amount of each service function group, and
the function regulation control information transmitting section uses the apparatus identification information to encrypt the function regulation control information and transmits the encrypted function regulation control information to the communication apparatus.

14. The customer center according to claim 11, further comprising:
a user database in which subscriber information assigned to the communication apparatus from the communication network, confidential apparatus identification information assigned beforehand to the communication apparatus for use in the decode process, and date/time information for acquiring at least the part of the service function group and use amount of each service function from the communication apparatus are associated with individual identification information assigned beforehand to the user system and stored;
a timer; and
a comparing section which compares present date/time information obtained by the timer with the date/time information stored in the user database,
wherein the function regulation control information transmitting section uses the apparatus identification information of the corresponding communication apparatus stored in the user database, to encrypt the function regulation control information, and transmits the encrypted function regulation control information.

15. The customer center according to claim 11, wherein the communication apparatus includes a function table in which the use amount and setting information indicating regulation/regulation cancellation are stored with respect to at least some of all service functions disposed beforehand, and
the function regulation control information transmitting section transmits the function regulation control information to change setting information of the corresponding function to regulation in the function table with respect to the communication apparatus, when payment is not confirmed within a given period from notification of the charge of each used service function terminal the user system, and transmits the function regulation control information to change the setting information of the corresponding function to regulation cancellation in the function table with respect to the communication apparatus, when the payment is confirmed later.

16. A user system which comprises a communication apparatus and which is connected to a customer center to bill a charge for a used function of the communication apparatus and to regulate/control the function via a communication network, the user system comprising:
an actual-use information transmitting section which transmits actual-use information including at least a part of a service function group included beforehand in the communication apparatus and use amount of each service function group to the customer center via the communication network; and
a billing information receiving section which receives billing information indicating the charge of each used service function sent from the customer center via the communication network.

17. The user system according to claim 16, further comprising:
a function regulation control information receiving section which receives function regulation control information sent from the customer center, to regulate the function of the communication apparatus; and
a function regulation process section which executes a function regulation process of the communication apparatus in accordance with the function regulation control information.

18. The user system according to claim 17, wherein the communication apparatus includes a function table in which the use amount and setting information indicating regulation/regulation cancellation are stored with respect to at least some of all service functions, and
the function regulation process section changes the setting information of the corresponding function in the function table in accordance with a content of the function regulation control information sent from the customer center.

19. The user system according to claim 17, further comprising a plurality of terminals connected to the communication apparatus,
wherein the actual-use information transmitting section transmits a terminal use information including information indicating the plurality of terminals and a difference between the number of terminals connected to the communication apparatus and the maximum number of connectable terminals in the communication apparatus as the actual-use information, to the customer center.

20. The user system according to claim 16, wherein the communication apparatus has a telephony function.
